(19) United States
(12) Patent Application Publication
(10) Pub. No.: US 2010/0225242 A1
(43) Pub. Date: Sep. 9, 2010

(54) GAS-DISCHARGE LAMP AND METHOD OF MANUFACTURING A GAS-DISCHARGE LAMP

(75) Inventor: Anatoli Saveliev, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/993,078

(22) PCT Filed: Jun. 19, 2006
(86) PCT No.: PCT/IB06/51953

§ 371 Date: Dec. 19, 2007

(30) Foreign Application Priority Data
Jun. 24, 2005 (EP) 05105675.2

(51) Int. Cl. H05B 41/36

(52) U.S. Cl. 315/276

(57) ABSTRACT

A gas-discharge lamp (1) with a lamp base (2) and with a lamp envelope (4) is described, which for fastening at the lamp base (2) in a base-sided area is surrounded by an electrically conductive sleeve (12) and which has a discharge vessel (6) with two electrodes (8, 9). In addition, the lamp (1) has two supply lines (10, 11) for the electrodes (8, 9). A first supply line (10) runs through the area of the lamp envelope (4) surrounded by the sleeve (12) and a second supply line (11) runs outside the area surrounded by the sleeve (12). The second supply line (11) is conductively connected with the sleeve (12). In addition, a method for the production of such a gas-discharge lamp (1) is described.

The invention relates to a gas-discharge lamp, preferably a high-pressure gas-discharge lamp as well as a method of manufacturing such a gas-discharge lamp. Furthermore, the invention relates to a lamp system with a corresponding gas-discharge lamp.

Gas-discharge lamps usually have a lamp envelope (in general also called burner), which is fastened firmly in or to a lamp base respectively. This lamp envelope mostly comprises an outer envelope as well as an inner envelope arranged therein, which inner envelope forms the discharge vessel into which two electrodes are projected as a rule arranged on opposite sides of the discharge vessel. Between these electrodes in operation, an electrical gas discharge, typically an arc, is ignited and maintained. For this purpose the electrodes are connected to supply lines in sealing sections arranged at the discharge vessel supply line via which lines the lamp can be attached to a circuit arrangement for voltage supply. The discharge vessel is filled under relatively high pressure with a gas, usually an inert gas or an inert gas mixture respectively. Typical examples of such gas-discharge lamps in the form of high-pressure gas discharge lamps are what are called MPXL (Micro-Power-Xenon-Light) lamps. Such lamps are used particularly for automobile headlights. The arc ignited in these lamps generates a high temperature, which essentially leads to the light emission of the inert gases in the discharge vessel as well as the added materials such as mercury and mixtures of metal halides. Then, the outer envelope serves among others for the absorption of the ultraviolet radiation, which is unavoidably generated besides the light in the desired visible wavelength area, due to the physical processes in the arc in the discharge vessel.

With many currently customary gas-discharge lamps, for example, also with the MPXL lamps, the fastening of the lamp envelope to the lamp base takes place by means of what is called a sleeve. This sleeve is a ring-shaped bush, mostly of spring steel, which is fastened to the outside of the lamp envelope after the production of the lamp envelope. This fastening takes place purely mechanically, as the spring steel is so designed, that is, formed, that the sleeve is clamped onto the lamp envelope. The sleeve is then pushed over the end of the lamp envelope, which points after assembly in the direction of the lamp base. The sleeve is held to the lamp base by means of several metal strips, which are injected with one end into the lamp base usually formed of plastic and extend from the base in the direction of the lamp envelope. At their free end, these respective strips are welded to the sleeve. The sleeve is electrically insulated vis-à-vis the environment by the fastening to the plastic base and is therefore at a freely floating potential. Usually, with these constructions one of the supply lines centrally leads out through the area of the lamp envelope surrounded by the sleeve or out of the lamp envelope respectively. When the lamp envelope is fastened to the lamp base, this supply line is connected to a supply line section in it which leads to the circuit arrangement needed for the operation of the lamp. As a rule, the second supply line is led out from the lamp envelope at an end of the lamp envelope pointing away from the base. It then runs on the outside of the lamp envelope and thus outside the area surrounded by the sleeve back to the lamp base and is likewise connected there to a sleeve section in the lamp base to the circuit arrangement for the operation of the lamp. Alternatively, or additionally, the lamp envelope can also be fixed to the lamp base in a sleeve by means of adhesive or the like.

As a rule, the arc in the lamp is ignited by applying a high voltage pulse. The breakdown voltage mostly amounts to several thousand volts, with the high-pressure gas-discharge lamps of the latest generation, for example, in the order of 20 kV. As soon as an electrical breakdown has taken place in the lamp, the lamp must be led by what is called a takeover process and further by a run-up process to a stationary operation. During the takeover and the run-up, the electrodes of the lamp and the lamp itself are heated up to the temperatures typical of the stationary operation. For maintaining the arc during the takeover and in the stationary operation, a substantially lower voltage is needed. First to ignite the gas-discharge lamp and then not to obstruct the stationary operation, a special circuit arrangement is needed. As a rule, such a circuit is called “ignition module”. Within the ignition module there is a capacitor that can be connected by two terminals to a voltage supply device (usually also called ballast). The charging process of the capacitor can be triggered directly by the ballast or also by other electrical arrangements integrated in the ignition module. This capacitor is switched by a switching element, for example, a spark gap or a thyristor to a primary coil of a transformer. For the ignition of the gas-discharge lamp the capacitor is charged in the ignition module by the ballast, which ignition module is switched parallel to the primary coil of the transformer by the switching element. The switching element can then connect through above a voltage specific of the element; however, with a respective embodiment of the ballast the switching element can also be controlled at a specific time, so that it connects through. For example, the switching voltage above which the switching element switches through can be specified by the ballast. As soon as a specific switching voltage is reached at the capacitor, the capacitor discharges via the switching element into the primary coil of the high voltage transformer. As a result of the discharging of the capacitor into the primary coil, the desired high voltage pulse is generated in the secondary coil of the transformer, which high voltage pulse then leads to the ignition of the lamp. As soon as the breakdown has taken place in the lamp, the lamp is supplied with electric power by the ballast via the secondary coil of the transformer and the return lead so that it is biased in the stationary state. An example of such a circuit is described in U.S. Pat. No. 5,986,413.

A problem with many of these lamp structures however is the fact that during the breakdown of the lamp, which leads to an extremely swift change of high voltage potential in the circuit arrangement, an error pulse with a length of only few nanoseconds and an amplitude of some hundred volts is generated. Then, voltages of above 1000 volts are reached at the terminals of the ignition module. Usually, this error pulse is also called glitch. Such a glitch pulse can spread by the connecting cable to the ballast and damage the ballast or components of the ballast respectively or even completely destroy them. This problem occurs particularly with a cold weather start of the lamp.

A measure, which can be taken to avoid the effects of the glitch pulse is the insertion of an inductive element, for example, in the form of an inductor, into the return line from the lamp to the ballast. It has turned out to be disadvantageous, however, that not all inductors are sufficiently effective particularly with modern lamps due to the high electric currents occurring during the switch-on process of the lamp. For example small toroidal-core inductors are saturated very quickly and thus have a very strongly reduced effect. The usage of a current carrying inductor at this place leads to a high voltage pulse on the return line of the lamp between the lamp and the inductor (up to an order of 10 kV in automotive MPLX lamps), which can lead to other undesired effects, for example, electrical flash-overs between the return line of the lamp and the parts in the lamp environment, which are below a low potential. This necessitates additional high voltage insulation measures in the ignition module.

It is an object of the present invention to provide a structure of the gas-discharge lamp of the kind specified above, so that the danger of the destruction of other electrical components, which are in contact with the gas-discharge lamp and/or the associated circuit arrangement or which are in the proximity of the gas-discharge lamp, particularly the danger of a destruction of the ballast by the swift change of high voltage potential occurring during the ignition of the gas-discharge lamp, is substantially reduced or prevented to a large extent respectively.

This object is achieved on the one hand by a gas-discharge lamp as claimed in claim 1 and on the other hand by a manufacturing method as claimed in claim 11.

In accordance with the invention it is then provided that with a gas-discharge lamp, in which the first supply line runs through the area of the lamp envelope surrounded by the sleeve and a second supply line runs outside the area surrounded by the sleeve, the second supply line is conductively connected to the sleeve.

As will yet be described hereinafter in detail by means of examples of embodiment it has turned out in numerous eaborate examinations that the parameters of the glitch pulse depend significantly on some small stray capacitances in the circuit arrangement for the operation of the lamp or respectively on a capacitance between the supply lines to the electrodes of the lamp and the surrounding ground. An important stray capacitance is then the capacitance that is formed between the supply line running through the sleeve connected to a free-floating potential and the sleeve on the one hand and on the other hand between the sleeve and the surrounding ground at ground potential, for example, between the ignition module shield usually at ground potential and for example, the parts of the headlight. Surprisingly, it has turned out that by a simple electrical contacting of the sleeve with the second supply line running past on the outside, the effect of this capacitance can be reduced and under specific conditions can be canceled almost completely, so that the effect of the glitch pulse is reduced considerably.

Such a gas-discharge lamp is manufactured according to the invention in such a way that first a lamp envelope with a discharge vessel, two electrodes and two supply lines for the electrodes is manufactured in a conventional way. As usual the lamp envelope can then be fixed by means of a sleeve fastened when mounted to the lamp base, which sleeve generally comprises metal and is therefore electrically conductive. For example, with a preferred mounting method first the sleeve can be pushed over the lamp envelope and clamped on it. After the correct positioning of the lamp envelope at the lamp base the sleeve is fastened to the base by means of strips. However, it is also possible for the sleeve to be fastened first to the lamp base and the lamp envelope is then pushed into the sleeve already lying in suitable position.

Then, in accordance with the invention a respective conducting contact is to be provided between the second supply line and the sleeve is to.

This can be effected for example by means of a wire bridge or the like, which connects the second supply line with the sleeve or with the strips respectively in contact with the sleeve. Basically, however it is also possible, that the implementation of the conducting contact between the second supply line and the sleeve takes place automatically when the lamp contacts the supply line sections in the base. For this purpose there may preferably be a contact between a supply line section present in or at the base for the second supply line of the lamp, particularly between a plug for the connection of the second supply line to the adapter in the base and one of the holding strips, which is connected to the sleeve or gets connected thereto. Naturally, a prerequisite is that this strip is also at least partly conductive. This variant has the advantage that an additional step can be done without during the final assembly of the lamp envelope on the lamp base. With another preferred variant the second supply line is designed in such a way, that this automatically comes into contact with the sleeve by sliding the sleeve over the lamp envelope.

The invention is particularly advantageous when used in the high-pressure gas discharge lamps described above in detail, particularly MPXL lamps. Furthermore, the invention can also be used to advantage with other gas-discharge lamps, which are fastened to the lamp base by means of a sleeve, while one of the supply lines runs to the electrodes through the sleeve and the other supply line runs outside the sleeve.

The dependent claims comprise each particularly advantageous respective arrangements and further aspects of the invention. In particular the method of manufacturing the gas-discharge lamp may also have further aspects similar to the dependent claims of the gas-discharge lamp.

Basically, the lamp envelope may have almost any shape. The supply lines can also be led from the lamp envelope to the lamp base in an arbitrary fashion. It is only essential that one of the supply lines run through the area surrounded by the sleeve and the other supply line run on the outside. Preferably, however, the lamp envelope is cylindrically designed—as with the lamps described above—and is held at the front face on the lamp base while the sleeve surrounds the lamp envelope in a cylinder section adjacent to the relevant facing. Adjacent is here to be understood as this cylinder section either bordering directly on the relevant front face or being arranged at a short distance from this front face.

The first supply line, preferably the up line, on which the high voltage pulses are provided for the ignition of the lamp, is preferably led out of the lamp envelope at the base-sided front face and thus runs through the area surrounded by the sleeve. The second supply line is led out of the lamp envelope at or in the proximity of the front face facing away from the lamp base and is led back from there to the lamp base on the outside at a distance to the lamp envelope.

It has turned out that the effect is best through the invented contacting of the sleeve, with the second supply line, if the sleeve is as long as possible and thus surrounds the first supply line over as long a distance as possible on its way to the electrode. With the conventional MPXL lamps, the length of the sleeve stretching in the longitudinal direction of the cylinder of the envelope is approximately 5 mm. In a preferred embodiment of the invention, the sleeve should preferably have a length of at least 1 cm stretching along the lamp envelope.

In a particularly preferred variant, the sleeve essentially stretches from the base-sided end of the lamp envelope to the base-sided end of the discharge vessel, for example, to the base-sided end of a discharge vessel arranged in an outer envelope. With this variant, the sleeve is as long as possible, without it covering the discharge area, from where the light is radiated.

In a particularly preferred variant of the invention an inductive element is arranged between the high voltage transformer and the discharge vessel in the first supply line or between the high voltage transformer and the first supply line, in a lamp, in which the first supply line, which serves for supplying high voltage pulses for the ignition of the lamp to the gas discharge lamp, is connected to a high voltage transformer of an ignition module, which inductive element can sustain a strong current pulse without saturation when the lamp is ignited. For it has further turned out that parallel to the two terminals of the secondary coil of the transformer, which is needed for the generation of the high voltage, as well as between the high voltage line running in the ignition module and other parts of the ignition module, which are at low potential, further stray capacitances are present, which influence the characteristic of the glitch pulse. With conventional ignition modules, these stray capacitances are approximately 5 to 10 pF. As a result of the inductance arranged between the high voltage transformer and the discharge vessel the discharge current is thwarted, which is built up across this stray capacitance during the ignition and which would discharge when in unthwarted condition across the lamp and the return line to the corresponding terminal of the ballast, is thwarted. That is, by means of this inductance it is ensured that the power fed to the stray capacitances instead of a short intensive glitch pulse decreases in the form of rather slow oscillations, while the resonant frequency of the oscillations is determined by the size of the stray capacitances and inductance and can thus be influenced. The inductor in the return line, already described above, customarily used in similar circuits can then be done without. Naturally, it is also possible to additionally use the inductor in the high voltage conductor.

A bar-core inductor with a high frequency ferrite bar core is used as a particularly preferred inductive element, because such an inductive element even of a particularly small design can stop high current electrical pulses without saturation.

A lamp system in accordance with the invention has besides the gas-discharge lamp in accordance with the invention and described earlier, a circuit arrangement necessary for the operation of the gas-discharge lamp, to which circuit arrangement the supply lines of the lamp are connected.

Such a circuit arrangement preferably has an ignition circuit arrangement with a capacitor that can be connected via two terminals to a voltage supply device (ballast), which capacitor is connected parallel to a primary coil of a transformer via a switching element. In addition, this circuit arrangement has a lamp circuit arrangement, in which the first supply line of the gas-discharge lamp is connected via the secondary coil of the transformer to a first terminal for connection to the ballast and the second supply line is connected to a second terminal for connection to the ballast.

The lamp circuit and the ignition circuit—apart from the common high voltage transformer—may basically be two separate circuits, which have their own terminals for connection to the ballast. Basically, it would also be possible to provide a separate ballast for each of the circuits. Most preferably, the circuit arrangement has only three terminals for connection to a ballast and is then designed in such a way that by the formation of the ignition circuit arrangement a first terminal is connected to the capacitor and to the primary coil of the transformer and a second terminal is connected to the other terminal of the capacitor and via the switching element to the other side of the primary coil. The first terminal is then further connected for the formation of the lamp circuit arrangement via the secondary coil of the transformer to a first supply line of the gas-discharge lamp, that is, to a first electrode. The second supply line of the gas-discharge lamp, that is, the second electrode, is then connected to the third terminal of the circuit arrangement. This construction saves more space than a construction with separate circuits and it particularly needs fewer terminals.

Irrespective of whether a circuit arrangement is used with two separate circuits with a total of four terminals or whether the aforementioned preferred circuit arrangement is used with only three terminals, in a preferred example of embodiment the terminals of the lamp circuit are connected to each other via a voltage-limiting element, which also becomes conductive in the event of a high voltage, for example, a Transil diode or a Zener diode. This voltage-limiting element can likewise contribute to reducing as swiftly as possible the high voltage between the terminals of the lamp circuit after the ignition and thus to reducing the danger of a ballast breakdown. Alternatively, instead of a Transil or a Zener diode also a suitable capacitive element could be used for this purpose, for example a capacitor with a capacitance of a few 100 pF to some nF.

Basically, in the lamp system in accordance with the invention the circuit arrangement can be structured separately from the gas-discharge lamp (which is called add-on ignition) and have corresponding terminals to which the gas-discharge lamp is detachably connected. That is, the gas-discharge lamp can then be replaced independently of the circuit arrangement.

Particularly preferably, however, the gas-discharge lamp with the circuit arrangement forms a lamp system unit, which can be inserted as a complete component, for example, into the headlights of an automobile and be replaced as one component. Then the circuit arrangement is preferably integrated essentially in a base housing of the gas-discharge lamp. Usually, such a lamp system unit is also called “lamp with integrated ignition module”. In accordance with the invention, the inserted inductive element is then preferably also arranged in the base housing, preferably directly in the base to which the lamp envelope is held.

Basically, the gas-discharge lamp in accordance with the invention, can be used in any headlights. In a preferred example of embodiment the headlight not only has a gas-discharge lamp in accordance with the invention, but a complete lamp system in accordance with the invention, that is, a gas-discharge lamp with the circuit arrangement described above.

These and other aspects of the invention are apparent from and will be elucidated with reference to the embodiments described hereinafter, though the invention should not be considered as limited to these.

### IN THE DRAWINGS

FIG. 1 shows a diagrammatic lateral representation with partial section of a conventional MPXL lamp with integrated ignition module,

FIG. 2 shows a simplified equivalent circuit diagram of the lamp in accordance with FIG. 1 with a usual circuit arrangement (ignition module),

FIG. 3 shows a diagrammatic lateral view with partial section of a structured MPXL lamp in accordance with the invention with integrated ignition module,

FIG. 4a shows a diagrammatic representation of the effect of a contacting in accordance with the invention of the second supply line and the sleeve with reference to an equivalent circuit diagram to FIG. 2

FIG. 4b shows a diagrammatic representation of the effect of an additional extension of the sleeve with reference to an equivalent circuit diagram as in FIG. 4a

FIG. 4c shows a diagrammatic representation of the effect of an inductive element in the first supply line with reference to the equivalent circuit diagram as shown in FIG. 4b.

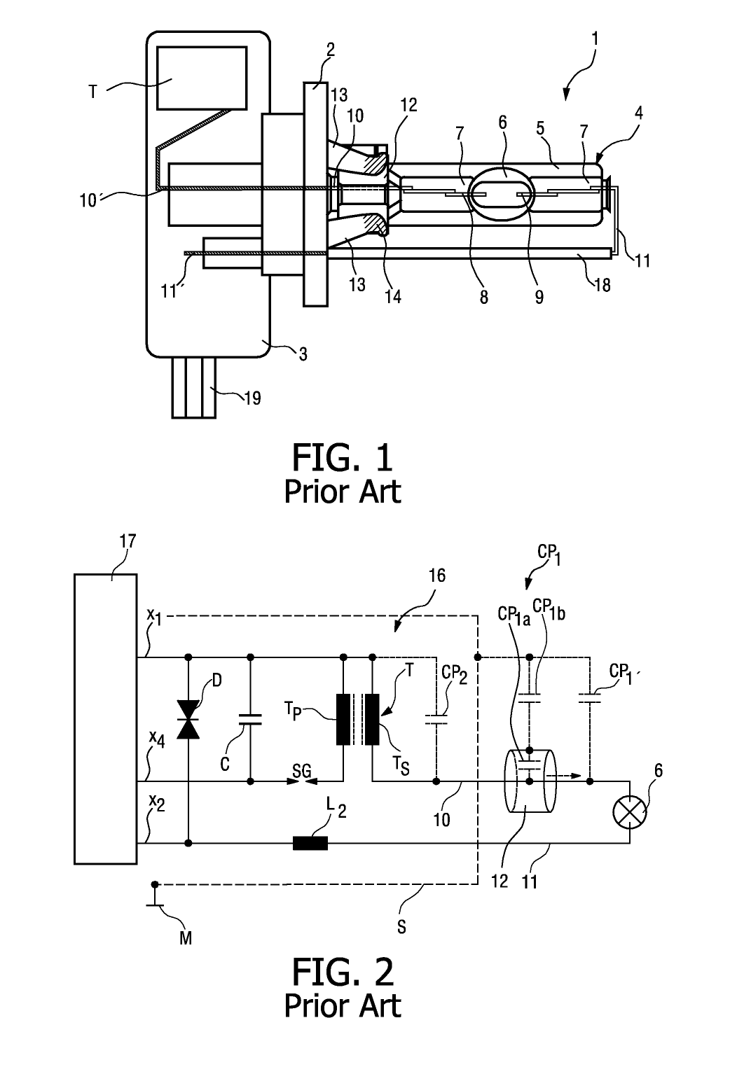

FIG. 1 shows a typical structure of an MPXL lamp with integrated ignition module 1, which has a lamp envelope 4, called burner below for short fastened in a lamp base 2. Here, the burner 4 comprises a cylindrical outer envelope 5 and an inner envelope located in it, which forms the discharge vessel 6. Inner envelope and outer envelope comprise quartz glass. The inner envelope 6 is held in the outer envelope 5 over extended glass sections 7 at the inner envelope 6, which extend in longitudinal direction of the outer envelope 5 and are connected to it at the facing side of the outer envelope 5. In the discharge vessel 6 there is a gas mixture under relatively high pressure, which gas mixture normally comprises inert gases and a mixture of metal halides and mercury. (Furthermore, there are also mercury-free lamps, which can be used here). The cavity between the outer envelope 6 and the discharge vessel 7 is preferably evacuated or filled with air or another gas or gas mixture respectively, for example, an inert gas mixture at a low pressure or the normal ambient pressure.

Two electrodes 8, 9 extend from opposite sides into the discharge vessel 6 and are connected within the glass sections 7, which are designed as what is called pinch for the sealing of the discharge vessel 6, to supply lines 10, 11, over which the electrodes 8, 9 can be wired. The two supply lines 10, 11 run out at the respective facing side from the outer envelope 5, which is likewise sealed gas-tight vis-a-vis the glass sections 7 forming the pinch.

As can be seen from FIG. 1 the burner 4 is held at the base 2 in such a way that the longitudinal axis of the burner 4 is perpendicular to the base 2 or its surface pointing to the burner 4 respectively. One of the two supply lines 10, usually the up line or high voltage line 10, is directly connected to a line section 10′ at the facing side within the base 2. The other supply line 11, the return line 11, is led back to the lamp base 2 on the outside in parallel at a distance to the burner 4 and is likewise connected there to a line section 11′ arranged in the base 2. This return line 11 is usually led back in a rigid ceramic tube 18 or the like, which serves on the one hand as insulation and on the other hand as a mechanical support for the return line 11.

For the fastening of the burner 4 to the lamp base 2 the outer envelope 5 of the burner 4 is enclosed at the base-sided end by a sleeve 12 made of spring steel, which—as the spring steel is formed in a suitable way—mechanically holds the outer envelope 5 by clamping. This sleeve 12 in its turn is held b holding strips 13, which at their base-sided end are co-injected in the lamp base 2 which is usually manufactured from injection molded plastic and which extend obliquely forward to the burner 4 and are connected at their burner-side end to the sleeve 12. As a rule, these strips 13 are likewise of spring steel and welded with the sleeve 12 at the end.

The mounting of the burner to the lamp base 2 is effected in such a way that the sleeve 12 is pushed over the finished burner 4 at the end, after which the burner 4 is pushed fit with the sleeve 12 between the holding strips 13 to the base 2, so that the supply lines 10, 11 contact the respective supply line sections 10′, 11′ (the contact spots are not explicitly shown in the Figure) and subsequently the holding strips 13 are fastened at the end by spot welding to the sleeve 12.

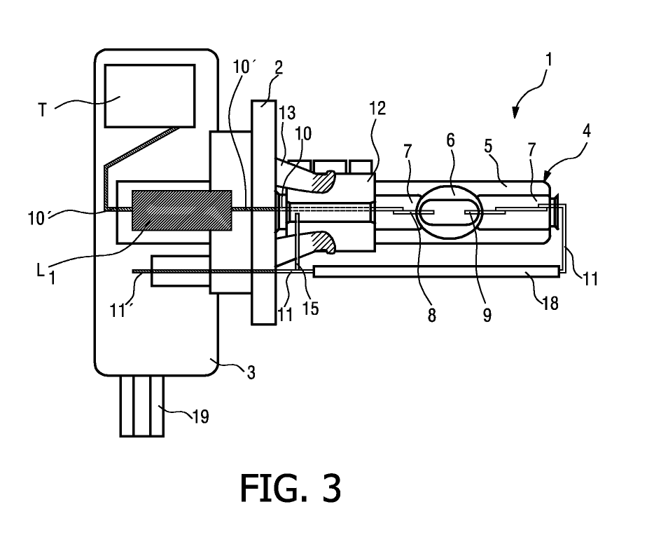

Inside the base housing 3 of the lamp base 2 is provided a circuit arrangement, the what is called ignition module, which serves to supply the lamp 1 with the necessary ignition and operating voltage. The main component of the ignition module is a high voltage transformer T to which the high voltage line 10 is connected (also compare FIG. 2). Such a lamp system unit comprising lamp 1 and ignition module is connected to a ballast (not represented in FIG. 1) over a plug connection 19 at the base housing 3. Usually, the base housing 3 is connected to ground potential. As the holding strips 13 are cast in the plastic of the base and thus have no electrical connection to the base housing 3, both these holding strips 13 and the metallic sleeve 12 connected to it, are at a non-defined, freely floating electrical potential.

The up line 10 runs, as can clearly be seen in FIG. 1, through the sleeve 12 which is on the freely floating potential, whereas the return line 11 runs on the outside past the sleeve 12.

In FIG. 2 is shown a circuit diagram for this conventional lamp together with the ignition module 16. Here, the ignition module 16 has three terminals x₁, x₂, x₄, via which the ignition module 16 is connected by the plug 19 represented in FIG. 1 to a ballast 17. This ballast 17 is represented only schematically in FIG. 2.

Between the terminals x₁ and x₂, the what is called lamp circuit is designed here, which essentially comprises the secondary coil Tₛ of a high voltage transformer T connected in series with the lamp or the discharge vessel 6, respectively. Here, the terminal x₁ is connected to a side of the secondary coil T_{S} of the high voltage transformer T, which is connected on the other side to the first supply line 10, to the up line 10, and to the lamp 1. The return line 11 of the lamp is connected to the terminal x₂, while optionally an inductive element L2, usually a toroidal-core inductor, is arranged in the return line 11. In addition, the terminals x₁, x₂ are connected to each other by a Transil diode D. The Transil diode D is to ensure that the high voltage generated during the ignition does not have too strong effects on the ballast 17. The inductance L₂ helps in the improvement of the EMI behavior of the lamp in continuous operation. Instead of the Transil diode D also a capacitor with a capacitance from a few 100 pF to some nF can be used.

Between the terminals x₁ and x₄ the what is called ignition circuit is built. For this purpose first a capacitor C is connected to the terminals x₁, x₄. The capacitor C is on the one hand directly connected to the first terminal of the primary coil T_{P} of the transformer T. On the other hand, the capacitor C is connected over a switching element, here a spark gap SG to the second terminal of the primary coil T_{P}. Thus the capacitor C is—apart from the interruption by the discharger SG—also connected in parallel in a specific way to the primary coil T_{P} of the transformer T.

In addition, FIG. 2 shows an environment connected to ground potential M and/or an EMV shield S (EMV=electromagnetic compatibility) of the ignition module, which is provided for example by the base housing 3 as well as further parts in the lamp environment, like for example, the reflector of a headlight. Likewise, this Figure schematically shows the sleeve 12 lying on floating potential.

Since the ignition module 16 in accordance with FIG. 2 is a preferred structure of the circuit arrangement used in connection with the invention, the way of operation and the problem of the ignition module 16 or the effect of the invention for the elimination of this problem are explained with reference to the ignition module and lamp structure in accordance with FIG. 2, without limiting the invention to this. Alternatively, for example, a structure can also be selected, with which the ignition circuit and the lamp circuit each have two separate terminals and apart from the transformer, whose primary coil is arranged in the ignition circuit and whose secondary coil is arranged in the lamp circuit, are completely separated from each other. In addition, it is subsequently assumed that the high-pressure gas discharge lamp 1 is preferably an MPXL lamp. However, the subsequent explanations analogously also apply to other particularly similar superstructures of the ignition module as well as to other types of gas-discharge lamps.

In order to ignite the lamp 1, first the capacitor C is charged via the terminals x₁ and x₄ of the ignition circuit. The spark gap SG is so dimensioned that it connects through at approximately 800 volts. This results in that the capacitor C charged approximately up to 800 volts in the primary coil Tp of the transformer T discharges via the spark gap SG. Thus in the secondary coil T_{S} of the transformer a high voltage of the order of 20 kV is built up, which is then present before the ignition in the high voltage section between transformer T and the discharge vessel 6 and thus in the supply line 10 opposite the terminal x₂ of the lamp circuit. The other supply line 11 is connected (via the inductive element L₁) to the terminal x₂ of the lamp and has a lower potential before the ignition.

As a rule, the lamp is started with an ignition pulse. If it does not get down to a successful start of the lamp 1, the capacitor C is recharged in the ignition circuit in order to be able to start the lamp with further ignition pulses. As soon as the desired breakdown takes place in the discharge vessel 6, the discharge vessel 6 itself can be regarded as a relatively low impedance resistance. The lamp 1 is then provided via the lamp circuit with the usual operating voltage form, depending upon the design of the driver, for example, a square-wave voltage between some 10 to a few 100 volts (depending on the design of the lamp). Then, for example, the respective half of the nominal voltage can be present on the terminals x₁ and x₂. An arbitrary voltage of up to some hundred volts can be present on the second terminal x₄ of the ignition circuit. This voltage should however not be so high that the spark gap SG connects through. With many ballasts this terminal is connected to a floating potential.

A problem with this structure is that with the ignition of the high-pressure gas discharge lamp 1 a swift change of potential of approximately 20 kV appears at a value below some 100 volts in the high voltage line between the secondary coil T_{S} of the transformer T. The stray capacitances CP charged at the beginning to a potential of approximately 20 kV are discharged over the lamp 1 in a short time in the form of very swift and high interference pulses which have a rise time of less than 1 ns, a duration of only a few ns and a height of 1000 volts and these interference pulses may penetrate the balast 17 in the direction of the ballast via the terminals x₁, x₂ and x₄ and may lead to damage or even destruction there. The terminal x₂ is involved most then. In order to find the exact cause of this what is called glitch pulse and discover the possibilities of influencing the parameters of the glitch pulse, a large series of different measurements were carried out, wherein the following dependencies were determined:

Apart from the components represented in FIG. 2, which determine the essential functions of the circuit arrangement 16, there are always various unavoidable parasitic components that may influence the behavior of the entire circuit structure. Most of these parasitic components do not play an essential role, it is true, because of their negligibly small values, yet some of the parasitic components are responsible for the building up of the glitch pulse. Then, the mechanism for the emergence of the glitch pulse is as follows:

As already described above, the ignition of the lamp 1 takes place through high voltage pulses induced in the secondary coil of the transformer. The rise times of the high voltage pulse are in the range between several 10 to some 100 ns. As a rule, these high voltage pulses have a positive polarity. However, this depends on the design of the driver circuit and of the transformer T. After the voltage has reached the breakdown value in the order of 20 kV, the desired breakdown takes place in the lamp and the lamp ignites.

During the ignition process of the high-pressure gas discharge lamp 1 the resistance of the discharge vessel 6 changes in a few nanoseconds from nearly an infinite value to a relatively small value. Thus, in the high voltage line between the secondary coil T_{S} and the lamp 1 the potential of approximately 20 kV is very swiftly reduced to a value below 100 volts. The time, in which the high voltage pulse, which led to the ignition, is reduced is determined by the breakdown process in the lamp 1 and takes place in a time of a few nanoseconds. The value dU/dT in the high voltage line between the secondary coil T_{S} and the lamp 1 (refer to FIG. 2) is then in the order of 20 kV/2 ns=10¹³ volts/s. The stray capacitances between the high voltage line and other components of the ignition module, of the shield and the environment are thereby discharged very rapidly, which leads to relatively high currents in the connecting lines to the ballast 17, particularly in the return line 11 from the discharge vessel 6 to the terminal x₂. The parameters of the over-current or the over-voltages respectively, which are caused by the operations described above, are dependent among others on the impedance of the respective connecting line.

In the special experiments, it has turned out that mainly specific stray capacitances play a large role with the causing of the glitch pulse.

The first group of disturbing capacitances are the capacitances CP₁, CP_{1′} between up line 10 in the area of the lamp and the surrounding ground, particularly base housing 3 connected to the ground-potential. In the area of the sleeve 12 this capacitance CP₁ can be seen as two series capacitances CP₁ₐ and CP_{1b}, the first capacitance CP₁ₐ being present between the up line 10 and the sleeve 12 connected to the freely floating potential and the second capacitance CP_{1b} being present between the sleeve 12 and the environment connected to ground. This is represented in FIG. 2 by two capacitors CP₁ₐ and CP_{1b}.

These stray capacitances CP₁, CP_{1′} are charged up to the ignition voltage of the lamp with the ignition pulse before the ignition process. After the breakdown of the lamp the positively charged side of the charged capacitors CP₁, CP_{1′} is connected by the discharge vessel 6 to other parts of the circuit arrangement 16. The glitch pulse caused by the capacitors CP₁, CP_{1′} then spreads in the direction of the terminals x₁, x₂, x₄ and finally in the direction of the ballast 17. A second stray capacitance responsible for the glitch pulse is the capacitance of the secondary coil T_{S} itself. This capacitance is represented in FIG. 2 as capacitor CP₂ which is connected in parallel to the secondary coil T_{S}. This capacitor CP₂ is likewise charged to the breakdown voltage during the rise of the ignition pulse. The positively charged side of this capacitor CP₂ is also connected to the return line 11 of the lamp 1 after the breakdown in the discharge vessel 6. The negative side of this stray capacitance CP₂ (if it concerns an ignition pulse with positive polarity, otherwise this side of the capacitor is connected to the positive potential) is directly connected to the terminal x₁ and indirectly connected to the terminal x₄ through the capacitor C, the primary coil Tp and the spark gap SG. A part of the energy of this parasitic capacitor CP₂ is taken up by the transil diode D. The terminal x₂ is most strongly affected by the super positionings of the glitch pulse caused by both capacitances.

The effect of this glitch pulse can be absorbed partly by the conventional inductive element L₂ as well as the transil diode D. However, these measures are often not sufficient. The inductive element often used in the form of a small toroidal-core inductor for EMI purposes gets saturated by the high current caused by glitch pulses and thus loses its inductive effect.

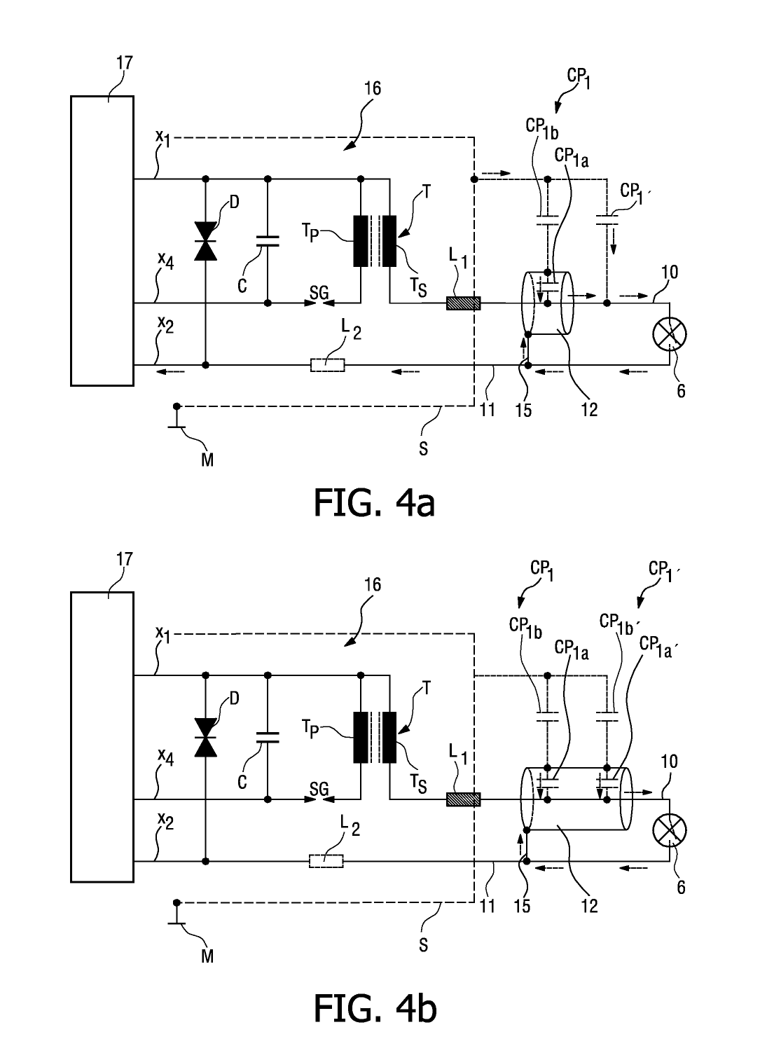

FIG. 3 shows a preferred example of embodiment of a gas-discharge lamp 1 structured in accordance with the invention, wherein an example is shown here, by a conventional MPXL lamp as is represented in FIG. 1, which was modified in the way in accordance with the invention. As a comparison between FIG. 1 and FIG. 3 shows, the essential difference of the invention is that now an electrical contacting exists between the sleeve 12 and the return line 11. The contacting in FIG. 3 is realized by a simple conductor bridge 15 just before the base housing. Alternatively, for example, the return line can be electrically connected in the base 2 also to one or several of the holding strips 13 injected into the base 2, as then the contact to the sleeve 12 is made via the holding strips 13.

In addition, with the example of embodiment represented in FIG. 3 as opposed to the customary sleeve used so far, the sleeve 12 is extended in the direction of the discharge vessel 6 of the gas-discharge lamp 1. Furthermore, in the supply line section 10′ to which the up line 10 is connected, there is a further inductive element L₁, which cannot be saturated at high currents. Preferably, an air inductor or a bar-core inductor can be used here. The inductive element L₂ for EMI purposes may then remain unchanged in order to reduce the disturbance level of the lamp in stationary operation.

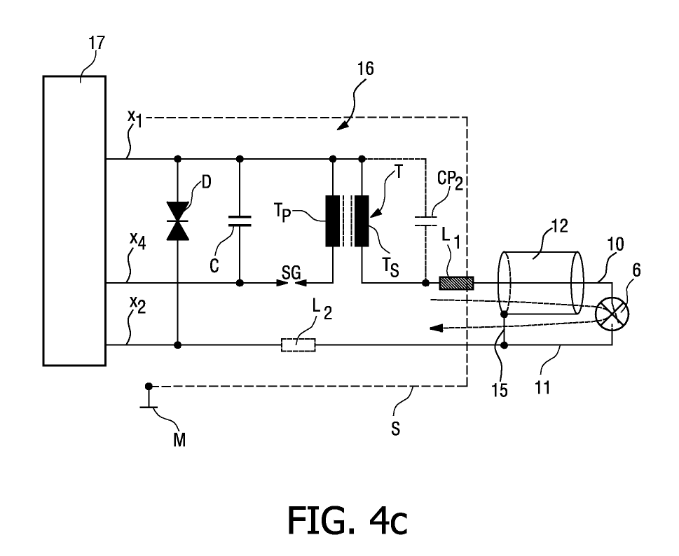

The FIGS. 4a, 4b and 4c show the effect of the different measures on the different stray capacitances and thus on the generation of the glitch pulse.

In FIG. 4a it is to be clearly recognized, how the stray capacitance CP_{1b} is connected to the low potential of the return line 11 and remains uncharged, as a result of the conductor bridge 15 between the sleeve 12 and the return line 11, while the stray capacitance CP₁ₐ between the high voltage conducting up line 10 and the sleeve 12 is short-circuited at the time of the breakdown by the discharge vessel 6 and the bridge 15. Thus, the effect of the overall stray capacitance CP₁ is eliminated and the glitch pulse caused by it is almost completely avoided.

FIG. 4b clarifies the effect that is obtained by the extension of the sleeve 12 in the direction of the discharge vessel 6. The capacitance CP₁ between the up line 10 and the surrounding ground, which is still given in the area of the up line 10 between sleeve 12 and discharge vessel 6, can then likewise be seen as a series capacitance CP₁, which is formed by a first capacitance CP₁ₐ between the up line 10 and the sleeve 12 which is connected to the freely floating potential as well as a second capacitance CP_{1b} between the sleeve 12 and the environment connected to ground, while the first capacitance CP₁ₐ is again short-circuited by the conductor bridge 15 between the sleeve 12 and the return line 11 at the time of the breakdown in the discharge vessel 6. Thus, the effect of the whole stray capacitance CP₁ is also eliminated. In the FIGS. 4a and 4b this effect of the extension of the sleeve 12 is represented for simplicity with two parallel stray capacitances CP₁, CP₁ only. More realistic would be a representation with a multiplicity of parallel stray capacitances, of which more and more are switched off, the longer the sleeve 12 contacted to the return line 11 is.

FIG. 4c shows the effect of the (optional) inductive element L1 arranged inside the base 2. This inductive element L₁ provides that the charge stored in the high voltage-conducting up line 10 due to the stray capacitance CP₂ slowly flows off via the discharge vessel and the return line 11 after the ignition in the direction, marked by the dashed arrow. Then this slowly flowing off is to be understood to mean that instead of a fast, intensive glitch pulse the charge is reduced in the form of slower oscillations. Naturally, this inductive element L₁ affects also other stray capacitances in the same way, which capacitances are designed for example between the base housing and the up line 10 in the area between the secondary coil T_{S} and the inductive element L₁.

The usual inductor L₂ is represented in the FIGS. 4a, 4b and 4c only in dashed boxes. Such an inductor L₂, which is additionally integrated into the return line, may be omitted from the up line 10 when the inductive element L₁ is used if measures are concerned for the reduction of the effects of the glitch pulse. The omission of the inductive element L₂ and the installation of the inductive element L₁ between the secondary coil T_{S} and the discharge vessel 6, however, has the considerable advantage that in doing so it is avoided that too high voltages can occur on the return line 11 (for example, in the conventional arrangement between the discharge vessel and the inductor L₂).

Naturally, the structure does not exclude that additionally yet another inductance L₂ is used, in order to improve for example, the EMI characteristics of the lamp.

Finally, it is pointed out once again that the circuits and methods represented concretely in the Figures. and the description are merely examples of embodiment, which can be varied by the expert to a large extent, without leaving the scope of the invention. Besides the measures in accordance with the invention to prevent the glitch pulse it is also particularly possible to insert one or several further inductors, which can additionally serve, for example, to improve the EMV behavior.

In addition, it is pointed out for completeness' sake that the use of the indefinite article “a” does not exclude that the characteristics concerned may also occur several times.

1-11. (canceled)

12. A lamp system with a gas-discharge lamp (1) comprising
a lamp base (2)
a lamp envelope (4), which is surrounded by an at least partly electrically conductive sleeve (12) in a base-sided area for the fastening to the lamp base (2) and which has a discharge vessel (6) with two electrodes (8, 9), and
two supply lines (10, 11) for the electrodes (8, 9),
and with a circuit arrangement (16) connected to the supply lines (10, 11) for the operation of the gas-discharge lamp (1)
wherein a first supply line (10) runs through the area of the lamp envelope (4) surrounded by the sleeve (12) and is connected to a high voltage transformer (T) of the circuit arrangement (16), wherein an inductive element (L₁) is arranged between the high voltage transformer (T) and the discharge vessel (6) in the first supply line (10) or between the high voltage transformer (T) and the first supply line (10),
and wherein a second supply line (11) runs outside the area surrounded by the sleeve (12) and wherein the second supply line (11) is conductively connected to the sleeve (12).

13. A lamp system as claimed in claim 12, characterized in that the lamp envelope (4) has a cylindrical design and is held at a front face against the lamp base (2), while the sleeve (12) surrounds the lamp envelope (4) in a cylinder section adjacent the related front face and wherein the first supply line (10) is led out of the lamp envelope (4) at the base-sided front face and the second supply line (11) is led out of the lamp envelope (4) at or in the proximity of the face of the lamp envelope (4) remote from the lamp base (2), and is led back from there to the lamp base (2) on the outside at a distance to the lamp envelope (4).

14. A lamp system as claimed in claim 12, characterized in that the sleeve (12) has a length of at least 1 cm extending along the lamp envelope (4).

15. A lamp system as claimed in claim 12, characterized in that the sleeve (12) essentially extends from the base-sided end of the lamp envelope (4) to the base-sided end of a discharge area.

16. A lamp system as claimed in claim 12, characterized in that a terminal for the second supply line coming from the lamp envelope and located in or at the lamp base is conductively connected to a holding element fastened to the lamp base and connected to the sleeve.

17. A lamp system as claimed in claim 12, characterized in that the inductive element (L₁) is integrated in a housing (3) of the lamp base (2).

18. A lamp system as claimed in claim 12, characterized in that the circuit arrangement (16) comprises
an ignition circuit arrangement comprising a capacitor (C) that can be connected via two terminals (x₁, x₄) to a voltage supply device (17), which capacitor is connected in parallel to a primary coil (T_{P}) of the high voltage transformer (T) via a switch element (SG), and
a lamp circuit arrangement, in which the first supply line (10) of the gas-discharge lamp (1) is connected via a secondary coil (T_{S}) of the transformer (T) to a first terminal (x₁) for the connection to the voltage supply device (17) and the second supply line (11) is connected to a second terminal (x₂) for the connection to the voltage supply device (17).

19. A lamp system as claimed in claim 18, characterized in that the circuit arrangement (16) has three terminals (x₁, x₂, x₄) for connection with a voltage supply device (17),
wherein under formation of the ignition circuit arrangement a first terminal (x1) is connected with the capacitor (C) and parallel to it with the primary coil (T) of the transformer (T) and a second terminal (x₄) is connected with the capacitor (C) and parallel to it over the switching element (SG) with the primary coil (TP),
and wherein under formation of the lamp circuit arrangement the first terminal (x₁) is connected over the secondary coil (T_{S}) of the transformer (T) with the first supply line (10) of the gas-discharge lamp (1), whose second supply line (11) is connected with a third terminal (x₂).

20. A gas-discharge lamp (1) for a lamp system as claimed in claim 12
comprising a lamp base (2)
comprising a lamp envelope (4), which is surrounded by an at least partly electrically conductive sleeve (12) in a base-sided area for the fastening to the lamp base (2) and which has a discharge vessel (6) with two electrodes (8, 9), and
comprising two supply lines (10, 11) for the electrodes (8, 9),
wherein a first supply line (10) runs through the area of the lamp envelope (4) surrounded by the sleeve (12), in which first supply line (10) an inductive element (L₁) is arranged, and wherein a second supply line (11) runs outside the area surrounded by the sleeve (12) and wherein the second supply line (11) is conductively connected to the sleeve (12).
